(19) United States
(12) Patent Application Publication
(10) Pub. No.: US 2004/0257739 A1
(43) Pub. Date: Dec. 23, 2004

(54) Safety disconnect unit with service recpetacle for mechanical and electrical systems

(76) Inventor: Joel A. Rencsok, Scottsdale, AZ (US)

Correspondence Address: Niro, Scavone, Haller & Niro, Suite 4600, 181 W. Madison, Chicago, IL, 60602, US

(21) Appl. No.: 10/465,028

(22) Filed: Jun. 19, 2003

(51) Int. Cl. H02H 5/04

(52) U.S. Cl. 361/104

(57) ABSTRACT

The present invention provides a disconnect unit for mechanical and electrical systems comprising a disconnect means and at least one receptacle. The disconnect unit provides the advantages of improving ease of installation while reducing manufacturing and installation costs. These advantages are accomplished, in general, by mounting the disconnect unit on, adjacent to or in a unit or units of the mechanical and electrical systems. Such systems use voltages in the range of 120 volts to 600 volts. The disconnect unit is contained in an enclosure and connected to a control panel inside the building by connective wiring run in the same conduit as the mechanical and electrical system units. Such systems may include but not limited to air conditioning systems, heating systems, air circulation systems and the like.

### FIELD OF THE INVENTION

This invention relates to disconnect units mounted to or adjacent to any mechanical and electrical systems, e.g., heating and cooling systems, i.e., air conditioning systems and heat pumps, air and water circulation systems and refrigeration systems as opposed to the typical installed disconnects and receptacles. Particularly, the invention concerns a disconnect unit for mechanical and electrical systems installed directly on or adjacent to the unit or units of the system's protective enclosure or inside the protective enclosure. The disconnect unit is primarily comprised of a disconnect means, at least one receptacle, at least one over current protection means and an enclosure.

### BACKGROUND OF THE INVENTION

A need exists to increase the safety of the electrical installations to mechanical and electrical systems installed on, adjacent to or within buildings containing these installations The mechanical and electrical building codes have changed to require a service receptacle within 25 feet (7.5 m) of these systems for servicing. This receptacle must remain energized when the system unit or units safety disconnect is de-energized.

The code further requires that the receptacle outlet shall not be connected to the load side of the equipment disconnecting means. It is pointed out that routinely this receptacle is installed separate from and at a remote distance from the mechanical and/or electrical system and the disconnect means associated with the system that the receptacle services.

Typically, mechanical and electrical systems are installed in, adjacent to, or on buildings, such as residential, retail, industrial and other commercial type establishments. The disconnect means for such systems are conventionally installed on, adjacent to or in the unit or units of the particular mechanical or electrical system, and will function to shut down the unit or multiple units of the system. Exemplary of such disconnect units is described in U.S. Pat. No. 6,075,435 which discloses an Air Conditioner Disconnect Switch which functions by utilizing fuses to break or connect the circuit. This patent does not disclose a service receptacle associated with any unit or device of the disclosed invention. Another disclosure, U.S. Pat. No. 6,366,449 discloses a power supply shut-off, but does not disclose use with mechanical and electrical systems such as heating and cooling systems or air or water circulation systems nor a receptacle associated with the power supply or shut off.

Other problems encountered with remotely located disconnect means and/or receptacles are their expense and greater difficulty of installation. These remotely installed service receptacles and/or disconnect means require up to three or more wire conductors and require to be connected to a power source outside or inside the building at a remote location from that of a system unit or units, e.g., air conditioning units, heat pumps and the like, located on, adjacent to or in the building. In other words, the remotely located disconnects and/or service receptacles must enter the building at some other location than the conductive wiring of each of the system unit(s) located on, adjacent to or in the building.

This type of installation results in higher costs, creates safety issues as well as inconvenience and installation problems.

Therefore it is desirable to have a disconnect means and service receptacle directly connected to or adjacent to the mechanical and/or electrical system unit or units.

### SUMMARY OF THE INVENTION

According to the present invention, a disconnect unit is provided which may be directly mounted on, adjacent to or in a mechanical and/or electrical system unit or units, e.g., an air conditioning unit, heat pump, an air or water circulation unit, refrigeration unit and the like.

Further in accordance with the present invention, a disconnect unit is provided which comprises a disconnect means, e.g., a standard knife switch, circuit breaker, a fuse disconnect switch or other overcurrent protection device and the like and at least one receptacle which may be mounted on, adjacent to or in a unit or units of a mechanical and/or electrical system.

Further in accordance with the present invention, an integral disconnect unit comprising disconnect means and at least one receptacle is provided that may be mounted on, adjacent to or in a new or existing mechanical and/or electrical system unit or units. Thus the connective wiring for the disconnect unit, which includes a disconnect means and at least one receptacle, may be installed directly with the connective wiring of the system unit or units resulting in reduced cost of installation while increasing the ease of installation.

The foregoing and other features of the invention are hereinafter more fully described and particularly pointed out in the claims.

The following description sets forth in detail certain illustrative embodiments of the invention, however it is intended that the scope of the invention be limited only by the scope of the claims and not the preferred embodiments discussed below.

### BRIEF DESCRIPTION OF THE DRAWINGS

FIG. 1 is a perspective view of one embodiment according to the invention showing hinged protective covers for different components of the disconnect unit.

FIG. 2 is a wiring diagram for one embodiment according to the invention.

FIG. 3 is a wiring diagram for an alternative embodiment according to the invention.

FIG. 4 is a wiring diagram for an alternative embodiment according to the invention.

FIG. 5 is a front view of another embodiment according to the invention showing the receptacle connected to the exterior of the enclosure.

FIG. 6 is a front view of another embodiment according to the invention showing a cut away view of the hinged cover with the receptacle located inside the enclosure of the disconnect unit.

### DETAILED DESCRIPTION OF THE PREFERRED EMBODIMENTS

A safety disconnect unit for mechanical and electrical systems has been designed and developed to improve ease of manufacture and installation while reducing the costs of installation. For the purposes of the present invention, the term “disconnect unit” is intended to mean an integral unit comprising disconnect means and at least one receptacle. It should be recognized by one of ordinary skill that such a unit will contain other components and while the different disconnect units illustrated herein comprise a single disconnect means and receptacle, it is intended that the scope of the invention include disconnect units comprising multiple disconnect means and/or receptacles.

As pointed out above, the disconnect units of the present invention are designed for mechanical and electrical systems. It is intended that mechanical and electrical systems within the scope of the present invention include any mechanical or electrical unit or units that require a disconnect unit or units for code restrictions, safety purposes or practical purposes. Such mechanical and electrical systems will include the following subcategories:

1. Environmental Control Systems which include but are not limited to heating and cooling systems including heat pumps and air-conditioners, air circulation systems including fans, commercial units, ventilation systems, air controlled systems for medical and laboratory facilities and the like;

2. Industrial Systems which include but are not limited to machinery cooling systems, ventilation systems, lighting systems, welding systems, deep well installations, compressors and the like; and

3. Recreational and Aesthetic Systems which include but are not limited to pools, spas, fountains, lighting displays, water circulation systems for aquariums and water parks and the like.

These systems may comprise a single unit or banks of units controlling the environment of different areas of a building, circulating water in a water park or operating machinery cooling system or several fountains and the like.

The disconnect unit of the present invention may be used on systems requiring all ranges of voltages, e.g., 120 volts ranging up to 600 volts or potentially higher and further operating at a range of frequencies, e.g., 50 Hertz, 60 Hertz and the like, either in single phase or three phrase. Thus the disconnect unit of the present invention has a great deal of flexibility for the system to which it may be installed and service.

The disconnect unit according to the present invention provides a number of additional advantages, other than the ones discussed above. The design of the disconnect unit may be readily adapted to the requirements of the particular mechanical or electrical system on which it is to be used. Also the disconnect unit may be adapted to meet various mounting and installation requirements. Moreover, as indicated above, the connective wiring for the disconnect unit may be run, i.e., in the same conduit, with the connective wiring for the unit or units of the particular mechanical or electrical system on which the disconnect unit is to be used. Therefore no additional holes need to be drilled in or on the building nor are additional support structures required to install a separate, remotely located service receptacle as is now presently being done in practice. Also, this type of installation, presently in use, requires significantly more connective wiring than that required for the disconnect unit of the present invention.

Most importantly, however, the disconnect unit of the present invention provides greater safety and convenience for the individual servicing or maintaining a unit or units for various mechanical and electrical systems. In order to service a particular unit or units, e.g., an air conditioner, may require various electrical devices such as power tools and lighting. These electrical devices need to be connected to a receptacle by a power cord. An electrical device plugged into a remotely located receptacle creates a number of safety and inconvenience problems. For example, a length of chord stretched to a mechanical or electrical system unit could be tripped over or be accidentally pulled from the socket of the receptacle causing the electrical device to malfunction and/or power off and thus creating in the least an inconvenience if not a hazard. The disconnect unit of the present invention minimizes these and similar problems.

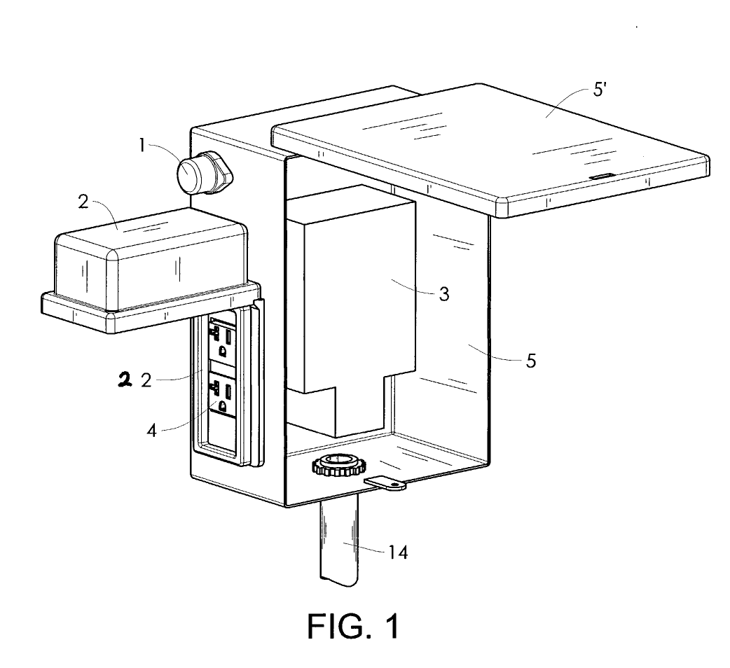

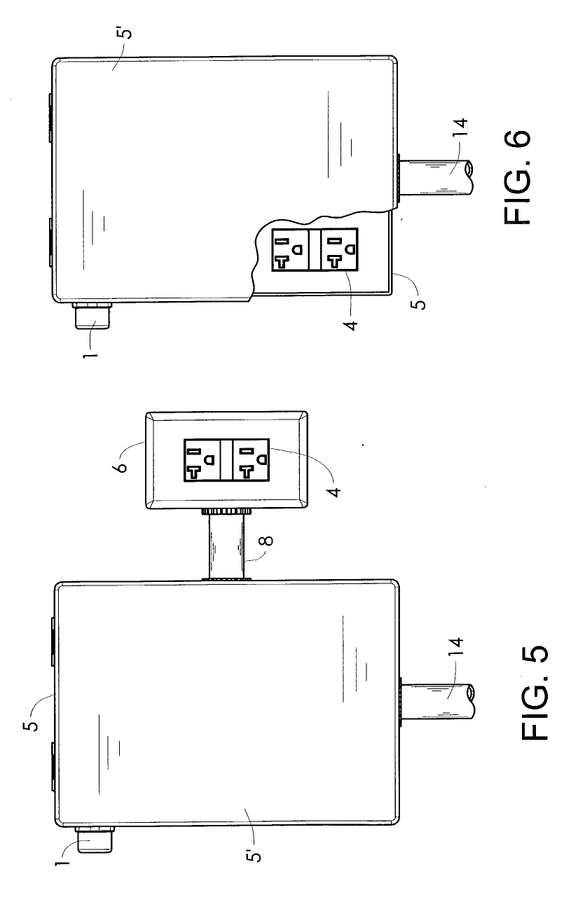

Referring now to the drawings and initially to FIG. 1, one embodiment of a disconnect unit according to the invention is illustrated. Protective holder 1 is located on the outside wall of the enclosure 5, although protective holder 1 alternatively may be installed inside enclosure 5. The over current protection means located inside fuse holder 1 protects the branch circuit (not shown) and receptacle 4. Receptacle 4 may be a standard receptacle or a Ground Fault Circuit Interrupter (G.F.C.I.). The receptacle 4 may be designed for most standard amperages, however, it is preferrably 15 or 20 amperes. Like fuse holder 1, receptacle 4 may be installed inside or outside enclosure 5. See FIGS. 5 and 6 which show alternative locations for receptacle 4. FIG. 5 shows short length electrical conduit 8 connecting attached protective box 6 containing receptacle 4. If receptacle 4 is installed outside enclosure 5, it may be optionally designed to be protected from the weather by cover 2. Cover 2 may be lockable or may “snap lock” to rim 22 surrounding receptacle 4.

Disconnect means 3 is installed inside enclosure 5 to disconnect the power from the serving load to the particular mechanical or electrical system unit. Disconnect means 3 may be, but not limited to, any of the following devices:

a. A standard knife switch

b. A fused disconnect switch

c. A motor circuit protector

d. A molded case circuit switch

e. A circuit breaker

f. A fused pullout

g. A fused terminal block

The disconnect means 3 may be accessed through lockable hinged cover 5′. The covers 2 and 5 are preferably made from the same material, although not required. Such material is preferably a durable, relatively high impact strength material, resistant to a wide range of weather conditions. For example, covers 2 and 5 may be formed sheet steel, cast from a non-corrosive aluminum or molded from an engineering plastic having relatively high impact strength, e.g., NORYL plastic manufactured by General Electric or a fiber glass reinforced polyester. The covers 2 and 5′ may be hinged on any side of the opening but preferably at the side of the opening for weather resistance and to prevent leakage.

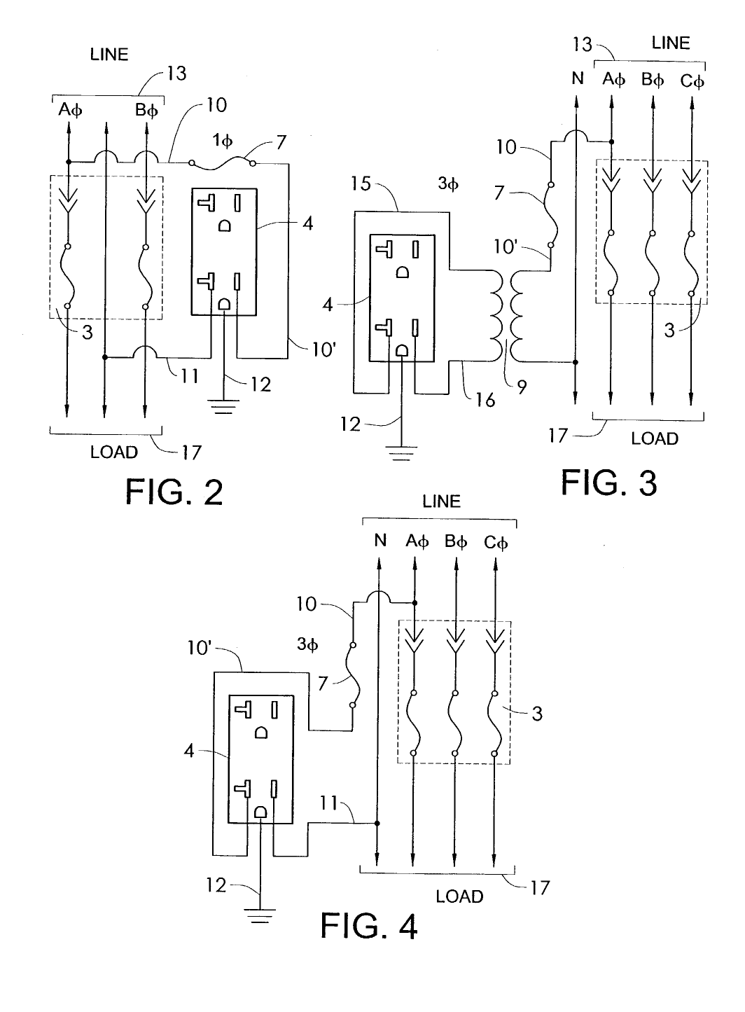

FIG. 2 shows one preferred embodiment for the wiring of receptacle 4 to the circuit of the disconnect unit. As pointed out above the receptacle 4 may be a standard but not limited to 15 or 20 ampere receptacle or a G.F.C.I. Fuse 7 is shown with its location in the circuit relative to receptacle 4, the serving load line 13, line conductor connection 10 and grounded (neutral) conductor wiring connections 11.

FIG. 3 shows a wiring diagram for another embodiment of the invention. Fuse 7 is located adjacent to voltage reducing means 9 which may be, e.g., an electrical transformer or an electronic voltage reducing device. Like several of the components making up the disconnect unit of the present invention, the voltage reducing means may be located inside or outside enclosure 5. FIG. 4 shows a wiring diagram which is an alternative embodiment to that shown in FIG. 3. The embodiment shown in FIG. 4 is absent voltage reducing means 9 but otherwise comprises the other components shown in FIG. 3. The grounding (green) conductor wiring connections are shown as 12 in FIG. 3 and FIG. 4.

The power from the serving load may be disconnected to the mechanical or electrical system unit or units by operating the disconnect means 3 of the disconnect unit which is mounted to the mechanical or electrical system unit. The system unit may then be serviced or repaired as needed without eliminating power from being supplied to receptacle 4. Thus, using voltage reducing means 9 eliminates the need to use separate wiring to supply power to receptacle 4.

Although the invention has been described in detail above, it is expressly understood that it will be apparent to persons skilled in the relevant art that the invention may be modified without departing from the spirit and scope of the invention. Various changes of form, design, or arrangement may be made to the invention without departing from the spirit and scope of the invention. Therefore, the above mentioned description is to be considered exemplary, rather than limiting, and the true scope of the invention is that defined in the claims.

What is claimed is:

1. A safety disconnect unit for mechanical and electrical systems comprising
an enclosure protecting access to the interior of said enclosure;
at least one receptacle mounted to said enclosure;
a disconnecting means for disconnecting power from the serving load of a unit of said mechanical and electrical system; and
wherein said disconnect unit is mounted to at least one unit of said mechanical and electrical system.

2. The disconnect unit according to claim 1 wherein said receptacle is contained inside said enclosure.

3. The disconnect unit according to claim 1 wherein said disconnect unit comprises at least one fuse contained within a protective fuse holder.

4. The disconnect unit according to claim 4 wherein said fuse is contained inside said enclosure.

5. The disconnect unit according to claim 1 wherein said disconnect unit further comprises a means to reduce the voltage of electrical power supplied to said at least one receptacle.

6. The disconnect unit according to claim 5 wherein said voltage reducing means is an electrical transformer.

7. The disconnect unit according to claim 1 wherein said receptacle is a Ground Fault Circuit Interrupter.

8. The disconnect unit according to claim 1 wherein said receptacle is 15 ampere.

9. The disconnect unit according to claim 1 wherein said receptacle is 20 ampere.

10. The disconnect unit according to claim 1 wherein said disconnect unit is a single phase unit used for voltage systems ranging from 120 volts to 600 volts.

11. The disconnect unit according to claim 1 wherein said disconnect unit is a three phase unit used for voltage systems ranging from 120 volts to 600 volts.

12. The disconnect unit according to claim 1 wherein said disconnect means is selected from the group consisting essentially of a knife switch, a fused disconnect switch, a motor circuit protector, a molded case circuit switch, a circuit breaker, a fused pull out or a fused terminal block.

13. The disconnect unit according to claim 1 mounted to at least one unit of environmental control system.

14. The disconnect unit according to claim 1 mounted to at least one industrial system.

15. The disconnect unit according to claim 1 mounted to at least one recreational and aesthetic system.

16. A method for improving the ease of installation and reducing the cost of installation for a disconnect unit to a mechanical and electrical system comprising mounting directly to the unit of said
mechanical and electrical system a disconnect unit comprising an enclosure with protecting access to the interior of said enclosure;
at least one receptacle mounted to said enclosure; and
a disconnecting means for disconnecting power from the serving load of a unit of said mechanical and electrical system.

17. The method according to claim 10 wherein said mechanical and electrical system is an environmental control system.

18. The method according to claim 10 wherein said mechanical and electrical system is an industrial system.

19. The method according to claim 10 wherein said mechanical and electrical system is a recreational and asethetic system.

20. An electrical disconnect unit for use with an electrical device comprising:
an enclosure in which an electrical disconnect is located;
at least one receptacle mounted to said enclosure;
a circuit for supplying electrical power to said receptacle and to the electrical device through said disconnect;
said circuit including a means for reducing the voltage of electrical power supplied to said receptacle.

21. The apparatus of claim 21 wherein said voltage reducing means is a transformer.

22. The apparatus of claim 20 wherein said circuit is configured to supply power to said receptacle when power to the electrical device is disconnected.
